(19) United States
(12) Patent Application Publication
(10) Pub. No.: US 2021/0009861 A1
(43) Pub. Date: Jan. 14, 2021

(54) SPLICE FOR PAVEMENT TAPES

(71) Applicant: 3M INNOVATIVE PROPERTIES COMPANY, St Paul, MN (US)

(72) Inventors: Cary A. Kipke, Austin, TX (US); David M. Dupuis, Austin, TX (US); Donald K. Larson, Cedar Park, TX (US)

(21) Appl. No.: 16/977,205

(22) PCT Filed: Feb. 6, 2019
(86) PCT No.: PCT/IB2019/050956

§ 371 Date: Sep. 1, 2020

Related U.S. Application Data
(60) Provisional application No. 62/643,318, filed on Mar. 15, 2018.

(51) Int. Cl. C09J 7/20; H02G 3/04; E01F 9/512; C09J 7/40

(52) U.S. Cl. CPC C09J 7/20; H02G 3/0437; E01F 9/578; C09J 7/40; E01F 9/512

(57) ABSTRACT

A splice tape for joining two pavement tapes in an end-to-end manner comprises a first adhesive layer; and a reinforcing layer disposed on one major surface of the adhesive layer, wherein the first adhesive layer is capable of adhering to a concrete or asphalt surface, wherein the reinforcing layer adheres to a first adhesive portion of a first pavement tape and to a second adhesive portion of the second adhesive tape when deployed.

### BACKGROUND

### Field of the Invention

The present invention is directed to a splice for joining pavement tapes in an end-to-end manner.

### Related Art

Pavement markings, such as those on the centerline and edgeline of a roadway, are important in order to provide visual guidance for motor vehicle drivers. Pavement marking materials are used as traffic control markings for a variety of uses, such as short distance lane striping, stop bars, pedestrian pavement markings at intersections, and long line lane markings on roadways. A common form of pavement marking materials is adhesive-backed tape that is applied to the roadway surface in desired location and length. The top surface of the tape has selected color and typically retroreflective characteristics. An exemplary pavement marking tape is described in U.S. Pat. No. 5,777,791.

In addition, such pavement tapes can be utilized in other applications. For example, a modified pavement tape having a continuous lengthwise cable channel can be utilized as a distribution cabling tape to deploy one or more distribution cables of a network to a neighborhood or other selected area for service, as is described in WO 2018/017475.

### SUMMARY

According to one embodiment of the present invention, a splice tape for joining two pavement tapes in an end-to-end manner comprises a first adhesive layer; and a reinforcing layer disposed on one major surface of the adhesive layer, wherein the first adhesive layer is capable of adhering to a concrete or asphalt surface, wherein the reinforcing layer adheres to a first adhesive portion of a first pavement tape and to a second adhesive portion of the second adhesive tape when deployed.

According to another embodiment of the present invention, a splice tape for joining two pavement tapes in an end-to-end manner comprises a first adhesive layer; a second adhesive layer; and a reinforcing layer disposed between and on a major surface of each of the first and second adhesive layers, wherein the first adhesive layer is capable of adhering to a concrete or asphalt surface, wherein the second adhesive layer is capable of adhering to a first adhesive portion of a first pavement tape and to a second adhesive portion of the second adhesive tape when deployed.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is a side view of an exemplary splice according to an embodiment of the present invention.

FIG. 1B is a partial exploded isometric view of the exemplary splice of FIG. 1A.

FIG. 1C is a schematic cross section view of the exemplary splice of FIG. 1A joining two segments of pavement tape.

FIG. 1D shows isometric views of a deployed splice.

FIG. 2 is an exemplary neighborhood deployment of an outdoor fiber pathway.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

The present invention is directed to a splice for joining pavement tapes, including retroreflective pavement tapes, in an end-to-end manner. The splice is formed from a durable material and provides structural integrity for the joined pavement tapes. This splice is particularly useful when deploying continuous pavement tapes over a large roadway area, such as for smart road applications.

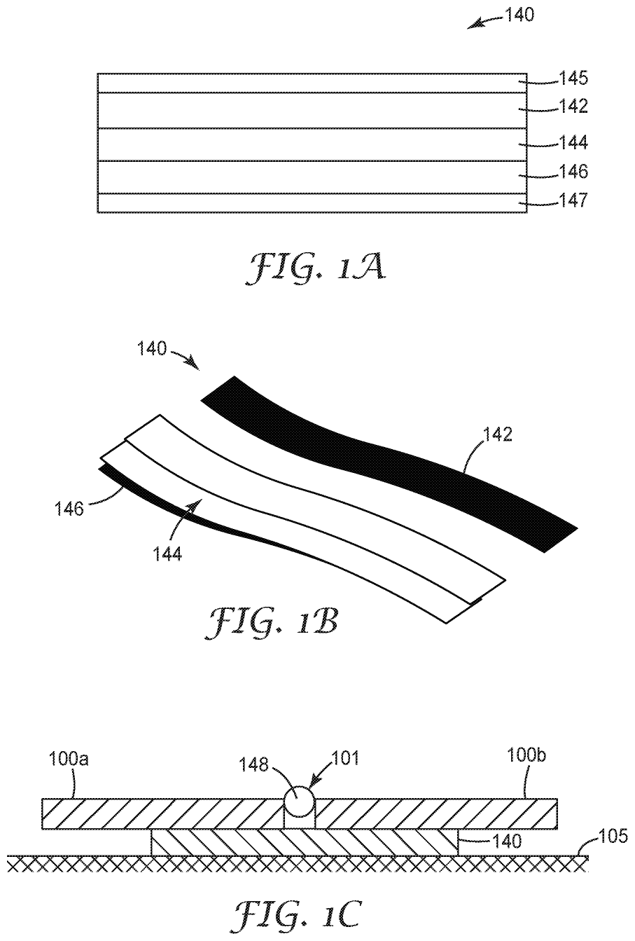

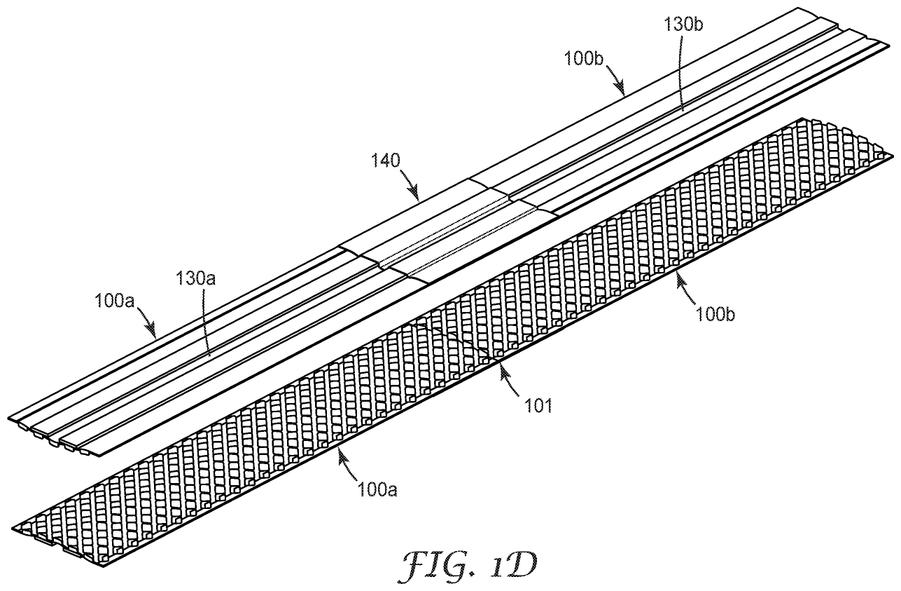

FIGS. 1A and 1B show different views of an exemplary splice tape 140 according to a first embodiment of the invention. FIG. 1C shows a schematic view of an exemplary splice deployment using the splice tape 140. FIG. 1D shows a bottom and a top view of a deployed splice.

A splice tape 140 is shown in side view in FIG. 1A. The splice tape 140 comprises a first adhesive layer 146 and a reinforcing layer 144 disposed on one major surface of the adhesive layer 146. The first adhesive layer 146 is formed from a material that is capable of adhering to a concrete or asphalt surface. Optionally, the splice tape 140 can further include a second adhesive layer 142. Adhesive layer 142 can be formed from the same or different adhesive as layer 146. In one example embodiment, the width of the splice tape 140 can be about 3″ to about 5″, preferably about 4″, in order to completely overlap the distribution cabling tapes being joined/spliced on the adhesive side of the tapes. The thickness of the adhesive layers 146, 142, can be from about 3 to 16 mil., preferably about 6-12 mil. The adhesive layers can comprise the adhesive materials described in more detail below.

The reinforcing layer 144 provides durability and structural integrity to splice tape 140 to help prevent dislodgment or breakage under an applied pulling or sheering force. In one exemplary aspect, the reinforcing layer 144 can comprise one or more overlapping strips of fiberglass tape.

It is noted that while some of the embodiments provided herein describe exemplary splice tape 140 being used to splice traditional pavement tape, pavement marking tape, or retroreflective pavement tapes in an end-to-end manner, alternatively, splice tape 140 can be used to splice an exemplary distribution cabling tape, such as described in PCT Pub. No. WO 2018/017475 and US Prov. Patent App. No. 62/567,516, each incorporated by reference herein in their entirety, as would be understood by one of ordinary skill in the art, given the present description.

Traditional pavement tapes, for example retroreflective tapes, can incorporate retroreflective elements durably adhered to a flexible substrate, which in turn is adhered to the roadway to delineate features on the surface such as lanes. Such pavement or retroreflective tapes are described in, for example, U.S. Pat. Nos. 5,777,791A, which is incorporated herein in its entirety. Commercially available pavement tapes include, for example, 3M™ Stamark™ High Performance Tape 3801 ES and 3M™ Stamark™ All Weather Tape 380AW.

The splice tape 140 described herein addresses a potential issue when joining pavement tape in the field. When deploying multiple rolls of tape in the field, in one approach, the roll of a first pavement tape can be completely laminated to the road surface, then a new roll can be mounted and threaded through a feeding device to restart the process. Using this approach, (1) the tape threading process may be time consuming, and (2) the ability to evenly butt the end of the new tape roll with the end of the depleted tape roll on the road may be challenging. In most cases, there is a gap left between the first and second tape ends. This gap could allow potential dislodgment of one pavement tape end relative to the position of the adjacent pavement tape end. This dislodgment presents a possible aesthetics problem, especially when deploying the pavement tape in a neighborhood. Further, for smart road applications, if sensors or cabling are connected between pavement tape segments, this gap could leave such sensors or media exposed. In addition, when using the conventional pavement tapes, oftentimes the upper surface of the pavement tape includes a low adhesion backside (LAB) coating that prevents strong adhesion to an overlapping tape. As such, according to one aspect of the present invention, a splice tape 140 can be utilized to join the different rolls of pavement tape, while still providing good overall structural integrity and, in some cases, protecting network or grid media disposed beneath.

A partial exploded view is shown in FIG. 1B, where the reinforcing layer 144 is disposed on adhesive layer 146, and adhesive layer 142 can optionally be applied to the other major surface of reinforcing layer 144.

Further, optionally, the splice tape 140 can include a first removable liner 147 that can be placed on a surface of adhesive layer 146 to protect the adhesive layer and to protect against inadvertent bonding to an object prior to deployment. During deployment, the liner 147 can be removed just prior to application of the adhesive layer 147 to the road surface. In addition, optionally, the splice tape 140 can include a second removable liner 145 that can be placed on a surface of adhesive layer 142 to protect the adhesive layer prior to deployment. During deployment, if the splice tape includes a second adhesive layer 142, the liner 145 can be removed prior to application of the adhesive layer 142 to the adhesive side of the distribution cabling tape 100a, 100b.

As shown in FIGS. 1C and 1D, the splice tape 140 can be configured to splice or join first and second pavement tapes 100a, 100b in an end-to-end manner when deployed. Each of the pavement tapes 100a, 100b has an adhesive layer capable of adhering to road, curb, or other surface. In one aspect, a more detailed description of an exemplary distribution cabling tape is described in PCT Pub. No. WO 2018/017475 and US Prov. Patent App. No. 62/567,516, each incorporated by reference above.

As shown in FIG. 1C, to join first pavement tape 100a to second pavement tape 100b in an end-to-end manner, splice tape 140 overlaps the underside (road facing) ends of pavement tapes 100a, 100b. In this manner, the splice tape 140 can cover and protect any network or grid media disposed there beneath as one pavement tape ends and a second pavement tape begins.

As shown in FIG. 1D, the upper illustration shows the bottom or adhesive side of a first pavement tape, in this example, a first distribution cabling tape 100a, being joined to a second distribution cabling tape 100b via a splice tape 140. As shown, each distribution cabling tape includes a continuous lengthwise channel 130a, 130b configured to receive at least one distribution cable. The splice tape 140 can conform to the shape of the lower side of the distribution cabling tapes, including channels 130a, 130b. The adhesive side of the splice tape 140 is laminated to the butted ends of the tapes so that it overlaps each distinct tape segment 100a, 100b by approximately 2-4 inches. Pressure can then be applied to the surface of the remaining release liner 147 to improve lamination of the splice tape 140, then liner 147 can be remove prior to application of the spliced tape to the road.

The lower illustration of FIG. 1D shows the upper or top side of the joined distribution cabling tapes 100a, 100b. At the interface 101 of the splice, as further shown in FIG. 1C, a bead of caulking material 148 can be applied to the gap 101 to fill any remaining space between the ends of the distribution cabling tapes. Removal of the tackiness of the caulking material 148 (such as 3M Strip Calk, available from 3M Company, St. Paul, Minn.) can be accomplished by dusting the surface of the filling material with road dirt or fine sand. It is cosmetically more appealing if the color of the detackifing material matches the color of the distribution cabling tape surface. Alternatively, an abrasive powder such as aluminum oxide can be used.

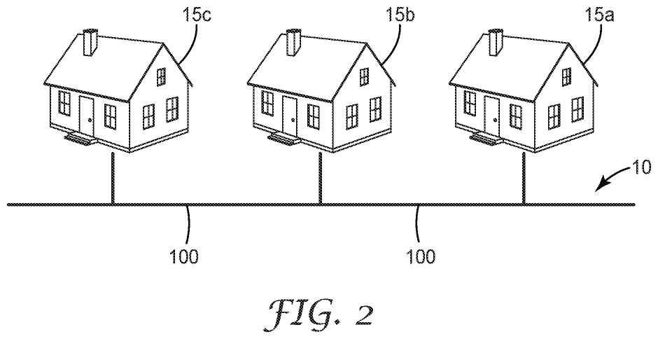

FIG. 2 is illustrative of an exemplary pavement tape system, such as an outdoor fiber pathway system for a neighborhood (e.g., houses 15a-15c). The outdoor pathway system 10 includes general pavement tape, or in this example, distribution cabling tape 100.

In one aspect, the pavement tape 100 can comprise a resilient polymeric base sheet having a first major surface and a second major surface. The tape 100 also includes an adhesive layer capable of adhering to a concrete or asphalt surface disposed on at least a portion of the major surface. In some alternative cases, such as when configured as a distribution cabling tape, the first major surface includes a continuous lengthwise channel formed in a first portion thereof. In other cases, the continuous lengthwise channel is formed on the surface of the adhesive layer. In addition, the continuous lengthwise channel is configured to receive at least one distribution cable. The distribution cable can include one or more electrical lines or optical fibers. In some aspects, the distribution cable can include one or more strength members such as is present in commercially available cable, such as OFS Toneable Mini LT Flat Drop Fiber Optic Cable (available from OFS Fitel, LLC, Norcross, Ga.), 3M™ Clear Fiber Drop Cable (available from 3M Company, St. Paul Minn.), or ROC™ Drop Dielectric Cable (available from Corning Inc., Hickory N.C.). Other suitable cables include CampusLink' Indoor/Outdoor cable (available from Prysmian Group, Lexington, S.C.). Alternatively, in some aspects, the distribution cable can comprise a conventional ribbon fiber having multiple fibers or a series of parallel optical fibers disposed on a filament tape to allow straightforward access to separate individual fibers by peeling away one or more fibers or peeling off a portion of the filament tape. As such, an exemplary distribution cable can have a circular, oval, or rectangular cross section profile. In other alternative embodiments, the lengthwise channel can be configured to accommodate more than one distribution cable.

The pavement tape 100 includes a resilient polymeric base sheet that can be formed from a single material, or, alternatively, different materials. For example, a first portion of the polymeric base sheet can be formed from a first material, such as a toughened or semi-rigid polymer material and other portions can be formed from a different material, such as a more flexible elastomeric (lower modulus) material. Such a composite base sheet can be formed by coextruding the two different polymers, as would be apparent to one of skill in the art given the present description.

At least a portion of the base sheet can be covered by an adhesive layer. The adhesive layer comprises a composition that is capable of adhering to a concrete or asphalt surface, such as a road, curb, or walkway surface. In one aspect, a pressure sensitive adhesive (PSA) is designed to adhere to a common road, curb, or walkway surface, such as concrete and asphalt surfaces, and to withstand the wide temperature variations, weather and chemicals present. For example, acceptable PSA formulations are described in U.S. Pat. Nos. 5,906,889 and 5,453,320, each of which is incorporated by reference herein in its entirety. In another aspect, the adhesive can comprise a heat activated adhesive. In addition, other types of adhesives can be used, depending on the duration of the intended deployment of the pavement tape. Such adhesive materials can be used in the splice tape 140 as well.

A second or top layer of the base sheet may be a flat surface or it may have a raised pattern surface of raised structures. The base sheet can be any color so that the tape can stand out (such as including white or yellow coloring) or it can blend into the surface upon which it is mounted (such as including gray or black coloring) or it can be covered with conventional road surfacing or resurfacing materials. Retroreflective elements, glass and/or ceramic beads, can be embedded directly on the second surface as is described in U.S. Pat. No. 4,388,359, which is incorporated by reference in its entirety. Alternatively, the second surface can be coated with either a thermoplastic or thermosetting layer. For flat markings, an example of a thermoplastic material is described in U.S. Pat. No. 4,117,192, which is incorporated by reference in its entirety, and for thermosetting an example material is described in U.S. Pat. No. 5,077,117, which is incorporated by reference in its entirety. For base sheets having a plurality of raised protuberances, example materials are described in U.S. Pat. Nos. 4,988,541, 5,683,746, 5,593,246, 6,479,132, 5,928,761, 5,227,221, and 5,763,000, each of which is incorporated by reference in its entirety. Additionally, other patterns and designs of raised protuberances are described in U.S. Pat. Nos. 4,388,359, 4,988,541, 5,683,746, and 4,681,401, each of which is incorporated by reference in its entirety. For applications where roads may be subject to snow and ice accumulation, exemplary base sheets designed to resist the action of snowplow blades are described in U.S. Pat. Nos. 4,129,673, 4,685,824, and 6,431,788, each of which is incorporated by reference in its entirety. Exemplary commercially available pavement marking tapes include those sold under the Stamark™ brand, including 380 IES and 380 AW models, available from 3M Company, St. Paul Minn.

Acceptable methods of forming a tape structure using the exemplary base sheets and adhesives described herein can include hot embossing, double sided embossing, patterned nip rolls, doctor blading (for adhesives), and pattern coating techniques. For example, patterned embossing rolls can be brought into contact with opposing sides of a web of the base sheet material to generate the desired patterns on each side of the base sheet (e.g., diamonds on the air side (e.g., top surface) and continuous channel on the road side). Doctor blades or pattern coating can be used to apply adhesives.

It is noted that while structure 100 is referred to herein as a “tape,” this term is not meant to exclude other types of adhesive-coated structures, such as adhesive-coated road patches, panels or markers that can provide a protective conduit or other type of pathway for cables. In addition, the pavement tape can also provide a protective pathway for electrical or power lines that are to be distributed through a neighborhood, or across a road, curb, street, parking lot or sidewalk, or for cabling repairs and/or splices. Moreover, the adhesive can be selected to provide either a temporary or more permanent type of bond to the road, curb, or walkway, thus providing a solution for short term events (such as concerts, sporting events, festivals, and the like), or for more longer duration deployment situations (such as subdivisions in development). In one example, tape 100 can include a pressure sensitive adhesive (PSA) layer, having a thickness of from about 3 to 16 mil, preferably about 6-12 mil.

In addition, while the tape embodiments described herein are often used in road, curb, sidewalk, or street applications, in alternative embodiments, the distribution cabling tape can be used to distribute cabling along other surfaces, such as along or up the side of a building, tower, bridge, or other structures. As such, the splicing tape 140 can be utilized in these implementations as well. Further, pavement tape 100 can be used to route and/or protect many different types of cables, including communication cables, power cables (such as low voltage power cables), sensor wires, co-axial cables, signal cables, and other conventional cables, or other types of equipment, such as sensors, RFID tags, embedded antennas, antenna feeds, and location markers.

Overall, the splice tape 140 contributes to the efficiency of applying pavement tape and to the road surface. The exemplary splice tape 140 provides the ability to splice a new roll of pavement tape onto a depleted roll of pavement tape in the field. The construction of the splice tape 140 provides ease of use and therefore a rapid splice timeframe. Minimal separation of the splice is observed after lamination to the road surface. The adhesion of the splice region to the road surface is also significantly improved due to the use of an adhesive designed for road surfaces.

While a preferred application of the splice tape is for smart road applications, as mentioned previously, other applications can include pathways for power, sensors or sensing or electronics, or as an outdoor fiber pathway system for telecommunication applications.

Various modifications, equivalent processes, as well as numerous structures to which the present invention may be applicable will be readily apparent to those of skill in the art to which the present invention is directed upon review of the present specification.

We claim:

1. A splice tape for joining two pavement tapes in an end-to-end manner, comprising:
a first adhesive layer; and
a reinforcing layer disposed on one major surface of the adhesive layer, wherein the first adhesive layer is capable of adhering to a concrete or asphalt surface, wherein the reinforcing layer adheres to a first adhesive portion of a first pavement tape and to a second adhesive portion of the second adhesive tape when deployed.

2. The splice tape of claim 1, further comprising a caulk material disposed between the two joined ends of the first and second distribution cabling tapes.

3. The splice tape of claim 1, wherein the first adhesive layer comprises a pressure sensitive adhesive.

4. The splice of claim 1, wherein the splice tape is disposed on the adhesive side of each of the first and second pavement tapes.

5. The splice of claim 1, wherein the first adhesive layer provides a substantially permanent bond to the concrete or asphalt surface.

6. A smart road network comprising the splice of claim 1.

7. A splice tape for joining two pavement tapes in an end-to-end manner, comprising:
a first adhesive layer;
a second adhesive layer; and
a reinforcing layer disposed between and on a major surface of each of the first and second adhesive layers, wherein the first adhesive layer is capable of adhering to a concrete or asphalt surface, wherein the second adhesive layer is capable of adhering to a first adhesive portion of a first pavement tape and to a second adhesive portion of the second adhesive tape when deployed.

8. The splice of claim 7, wherein the reinforcing layer comprises one or more layers of glass reinforcing tape.

9. The splice of claim 7, wherein the splice tape further comprises a first removable liner disposed on another major surface of the first adhesive layer, the removable liner being removable prior to deployment of the first adhesive layer onto a roadway or other surface.

10. The splice of claim 9, wherein the splice tape further comprises a second removable liner disposed on a second major surface of the second adhesive layer, the second removable liner being removable prior to adhering the splice tape to the first and second pavement tapes.

11. The splice of claim 7, further comprising a caulk material disposed between the two joined ends of the first and second distribution cabling tapes.

12. The splice of claim 7, wherein the first and second adhesive layers have the same composition.

13. The splice of claim 7, wherein the first and second adhesive layers each have a different composition.

14. The splice of claim 7, wherein the splice tape is disposed on the adhesive side of each of the first and second distribution cabling tapes.

15. The splice of claim 7, wherein the first adhesive layer provides a substantially permanent bond to the concrete or asphalt surface.

16. A smart road network comprising the splice of claim 7.
